(19) United States
(12) Patent Application Publication
(10) Pub. No.: US 2026/0285689 A1
(43) Pub. Date: Sep. 24, 2026

(54) CLEANING OF CO2 CONTAINING FEED GASES

(71) Applicant: TOPSOE A/S, Kgs. Lyngby (DK)

(72) Inventors: Martin ØSTBERG, Kgs. Lyngby (DK); Birgitte Staal HAMMERSHØI, Kgs. Lyngby (DK); Mads Kristian KAARSHOLM, Kgs. Lyngby (DK); Christian PILEKÆR, Kgs. Lyngby (DK); Thomas Sandahl CHRISTENSEN, Kgs. Lyngby (DK); Morten THELLEFSEN, Kgs. Lyngby (DK)

(73) Assignee: TOPSOE A/S, Kgs. Lyngby (DK)

(21) Appl. No.: 19/475,971

(22) PCT Filed: Apr. 22, 2024
(86) PCT No.: PCT/EP2024/060944

§ 371 Date: Oct. 16, 2025

(30) Foreign Application Priority Data
Apr. 21, 2023 (DK) PA202300339

(51) Int. Cl. C01B 32/50; B01D 53/04; C01B 32/40; C10G 2/00

(52) U.S. Cl. CPC C01B 32/50; B01D 53/04; C01B 32/40; C10G 2/30; B01D 2256/22; B01D 2257/104; B01D 2257/302; B01D 2257/306

(57) ABSTRACT

The present invention relates to a process for cleaning a CO₂-rich gas feed, in particular for removing sulfur-containing impurities, and optionally oxygen.

### TECHNICAL FIELD

The present invention relates to a process for cleaning a CO₂-rich gas feed, in particular for removing sulfur-containing impurities, and optionally oxygen (O₂).

### BACKGROUND

Carbon dioxide (CO₂) is commercially available in different grades. Typically, “food grade” or “beverage grade” CO₂ has a purity of 99.9%. However, for processes involving catalytic conversion of CO₂ to other chemical products (e.g. power-to-X), impurities such as sulfur-containing compounds in the CO₂ stream may poison the synthesis catalyst, even when present at concentrations of 0.00001% (100 ppbV) or even lower. Oxygen (O2) will only rarely be an actually poison for the catalyst, but the ability to oxidize the catalyst materials may lead to structural damage to the catalyst leading to mechanical or catalytic degradation if present in higher concentrations, e.g. higher than 100 ppm.

Despite the high purity of certain CO₂ sources, it has been discovered that further purification is required to avoid catalyst poisoning or degradation of downstream synthesis catalyst.

Sulfur compounds are well-known as catalyst poisons, which react with the active material on the catalysts and render them catalytically inactive. For some catalysts, oxygen (O2) is also a critical substance leading to catalyst degradation and e.g. the Cu-based methanol catalyst is prone to oxidation by oxygen and therefore high concentrations of oxygen present in the CO2 (or H2) feed gases to a methanol plant have to be removed at a position upstream the methanol catalyst.

The catalyst/absorbent systems developed to remove sulfur impurities from CO2 have been found to be sensitive to relatively high oxygen concentrations as well, and a solution has been developed to remove the O2 from the CO2 gas before the CO2 gas enters the sulfur removal process.

Systems and processes for purification of CO2 streams are known from e.g. EP2457636, CN112999843, US2007028764, US200702877, US2022333015 and CN112957872.

### SUMMARY

It has been found by the present inventor(s) that sulfur cleaning of CO₂ feeds is necessary and can be carried out after addition of 2% H₂ by adsorption on a metal-promoted guard material to such a degree, that the CO₂ stream afterwards contains <10 ppbV sulfur. It has also been discovered that any oxygen in the CO₂ feed can influence the sulfur capacity and mechanical integrity of a guard material.

So, in a first aspect the present invention relates to a process for cleaning a CO₂-rich gas feed, said CO₂-rich gas feed comprising at least 80 wt % CO₂ and one or more sulfur-containing impurities; wherein said process comprises the step of:
passing the CO₂-rich gas feed together with a hydrogen-rich feed over a guard material, and adsorbing one or more sulfur-containing compounds on said guard material, to provide a cleaned CO₂-rich gas stream.

A process for production of a syngas stream is also provided, said process comprising the process described above, and further comprising:
providing at least a portion of said cleaned CO₂-rich gas stream from the process described above;
providing a second hydrogen-rich feed, optionally obtained from the process of electrolysis of water in one or more electrolysis unit(s);
reacting said portion of the cleaned CO₂-rich gas stream with the second hydrogen-rich feed, to provide at least one syngas stream.

A process is also provided for production of a synthetic fuel stream, said process comprising the process described above, and further comprising the step of converting said at least one syngas stream to at least one synthetic fuel stream, preferably being a MeOH (methanol) stream, a DME (dimethyl ether) stream, or a synthetic fuel stream, where the synthetic fuel could be aviation fuel, gasoline, diesel or similar.

Additional aspects are presented in the following description text, figures and claims.

### LEGENDS

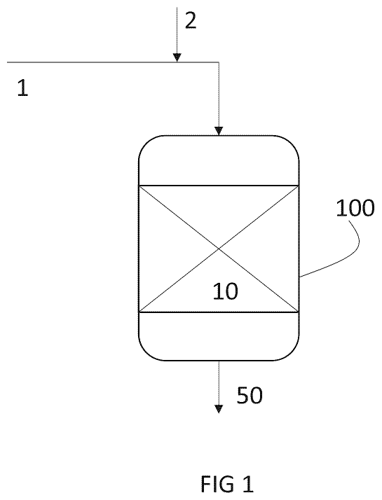

FIG. 1 shows a simple layout of one embodiment of the process of the invention.

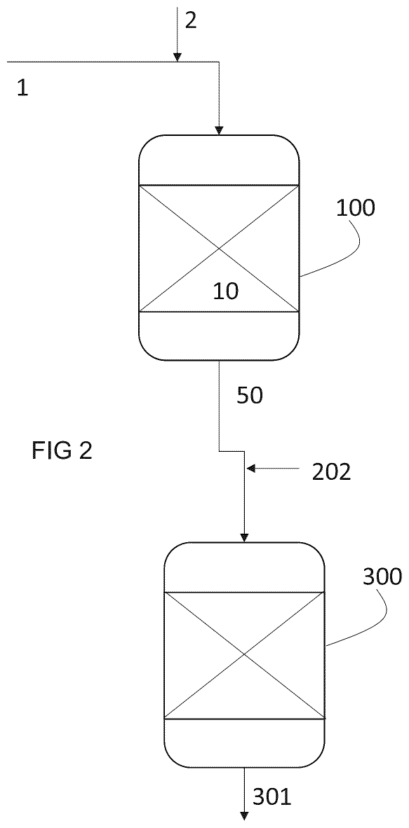

FIG. 2 shows a layout for production of a syngas stream.

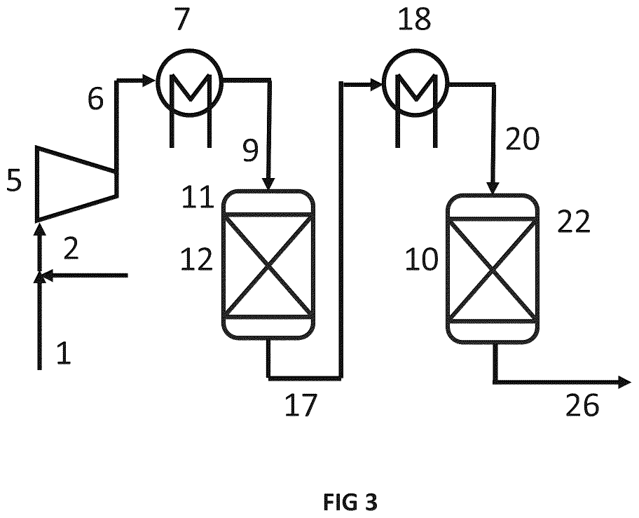

FIG. 3 shows another layout of the CO₂ gas purification process

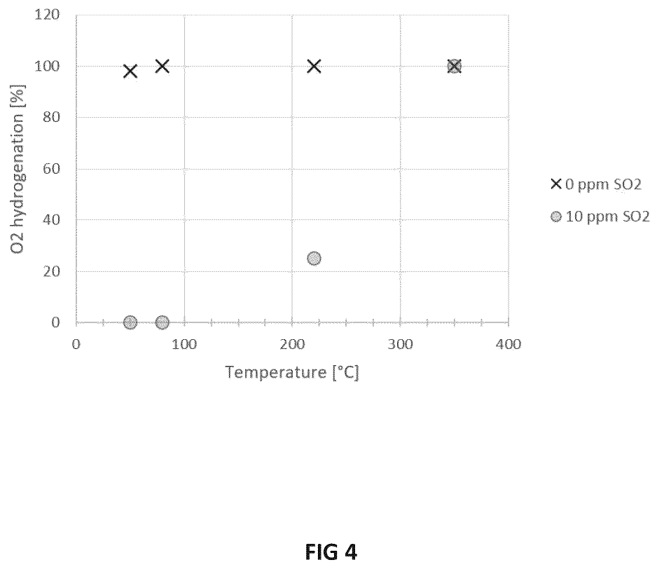

FIG. 4 shows the data for Example II

### DETAILED DISCLOSURE

Unless otherwise specified, any given percentages for gas content are %, ppm (parts per million) or ppb (parts per billion) by volume. All feeds are preheated as required. Unless specified, the concentrations will be given on dry basis, i.e. without taking any water present into account.

A cleaned CO₂ stream is defined as the outlet stream from the CO₂ cleaning process, in which minimum 95% of the combined sulfur containing impurities in the feed is removed or the sum of sulfur containing impurities in the clean CO₂ stream is lower than 500 ppb (parts per billion by volume), preferably lower than 100 ppb and most preferably lower than 50 ppb.

The sum of sulfur containing in the cleaned CO₂ stream should be understood as sulfur-equivalents, i.e. 100 ppb SO₂ correspond to 100 ppb sulfur whereas 100 ppb CS₂ correspond to 200 ppb sulfur.

Similarly cleaned CO₂ stream is defined as the outlet stream from the CO₂ cleaning process, in which minimum 95% of the oxygen in the feed is removed or the O2 concentration in the clean CO₂ stream is lower than 200 ppm, preferably lower than 100 ppm and most preferably lower than 50 ppm.

Syngas is used as reference for a synthesis gas, a gas mixture comprising hydrogen, carbon monoxide, carbon dioxide and typically water as steam and methane. It is referred to as syngas/synthesis gas because it is the feed for a downstream catalytic synthesis leading to the desired product. In some application the feed downstream the referred purification can be mixed with hydrogen and be used as synthesis gas e.g. for methanol synthesis in other applications, the purified gas may after mixing with hydrogen and optionally steam need conversion in a reverse water gas shift reactor (RWGS) or combined RWGS and methanation reactor to form the final synthesis gas for the synthesis of the final product.

The proposed solution ensures that the feed gases for any downstream conversion to synthesis gas and synthesis for chemicals like MeOH, DME, FT (Fischer Tropsch) synthetic fuels, TIGAS based gasoline etc. will be unproblematic with regard to sulfur and oxygen poisoning of the downstream synthesis catalyst. This will ensure that operation can be made over time and allow catalyst lifetime as expected for industrial catalyst.

In a first aspect, therefore, a process for cleaning a CO₂-rich gas feed is provided.

The CO₂-rich gas feed provided to the process suitably comprises at least 90 wt % CO₂, such as at least 95 wt % CO₂, such as at least 99.0 wt % CO₂, preferably at least 99.5 wt % CO₂, more preferably as at least 99.9 wt % CO₂. The CO₂-rich gas feed is thus already of high purity prior to the process of the present invention.

Suitably, the CO₂-rich gas feed is derived from a renewable source, such as:
combustion or gasification of a lignocellulosic biomass such as wood products, algae, grass, forestry waste and/or agricultural residue;
combustion or gasification of municipal waste, in particular the organic portion thereof, where the municipal waste is defined as a feedstock containing materials of items discarded by the public, such as mixed municipal waste given in EU Directive 2018/2001 (RED II), Annex IX, part A;
microbial conversion of nitrogen-rich renewable feedstock such as manure or sewage sludge;
fermentation of hydrocarbon (sugar) rich feed streams such as corn, sugar cane and beets.

The CO₂-rich gas feed can also be obtained from direct air capture processes, metallurgical processes, cement production or fossil fuel combustion.

The CO₂ concentration in most of the above-mentioned gas streams may typically be too low for further chemical processing and a concentration step is required to increase the CO₂ concentration to the desired value as mentioned above.

The CO₂-rich gas feed comprises one or more sulfur-containing impurities. The one or more sulfur-containing impurities within the CO₂-rich gas feed may be selected from organosulfur compounds such as thiols, sulfides, disulfides, sulfones, sulfoxides and thioketones, CS₂, COS, SO₃, SO₂ and H₂S, preferably H₂S and SO₂, most preferably SO₂. The total content of SO₂ in the CO₂-rich gas feed is 0.1-50 ppm SO₂, such as 0.2-10 ppm SO₂, such as 1-10 ppm SO₂, such as 0.5-5 ppm SO₂, such as 1-5 ppm SO₂.

The CO₂-rich gas feed may also comprise water. However, high concentrations of water can limit/inhibit the uptake of sulfur compounds on the guard material and limiting the water concentration will provide for a more efficient operation of the guard system. Suitably, therefore, the total content of H₂O in the combined feed of the CO₂-rich gas feed and the hydrogen-rich feed, after mixing of said feeds, is no more than 10 vol %, preferably no more than 5.0 vol %, preferably no more than 1.0 vol %, e.g. approximately 0.5 vol %.

The CO₂-rich gas feed may—in certain cases—comprise oxygen (O₂). Oxygen may also contaminate, poison or lead to degradation of downstream catalysts and guard material, so any oxygen in the CO₂-rich gas feed should often be reduced or eliminated. The total content of O₂ in the CO₂-rich gas feed, is 50-10,000 ppm O₂, such as 50-5,000 ppm O₂, such as 100-3,000 ppmV O₂.

Generally, the process comprises the step of: passing the CO₂-rich gas feed together with a hydrogen-rich feed over a guard material, and adsorbing one or more sulfur-containing compounds on said guard material, to provide a cleaned CO₂-rich gas stream.

In an embodiment, the CO₂-rich gas feed additionally comprises oxygen (O₂), and the process comprises the additional step of:
passing the CO₂-rich gas feed together with said hydrogen-rich feed over a catalyst active in hydrogenation of oxygen and reducing the oxygen in the CO₂/H₂ gas mixture, to provide a first CO₂-rich gas stream,
prior to the step of passing the CO₂-rich gas feed over the guard material for absorbing one or more sulfur-containing impurities, to provide a cleaned CO₂ rich gas stream.

The CO₂-rich gas feed to be purified may be first mixed with a hydrogen-rich feed, which acts as a reductant for one or more sulfur-containing impurities, and optionally for oxygen, in the CO₂-rich gas feed. The hydrogen-rich feed to the process comprises at least 90 wt % hydrogen such as at least 95 wt % hydrogen such as at least 98 wt % hydrogen.

In one embodiment, hydrogen is suitably added such that, the total content of H₂ in the combined feed of the CO₂-rich gas feed and the hydrogen-rich feed, after mixing of said feeds, is 0.2-10 vol % H₂ such as 0.5-3 vol % H₂. The advantage of this embodiment is that addition of H₂ is controlled, so as to limit undesired side reactions, e.g. methanol formation. The addition of hydrogen should always be sufficient to achieve excess H₂ in the product gas exiting the guard material.

In one embodiment, hydrogen is suitably added such that, the molar ratio H₂:O₂ is greater than 2 in the combined feed of the CO₂-rich gas feed and the hydrogen-rich feed, after mixing of said feeds and the purified CO₂ leaving the CO₂ purification system contains 0.2-10 vol % H₂ such as 0.5-3 vol % H₂. The advantage of this embodiment is that addition of H₂ is controlled, so as to limit undesired side reactions, e.g. methanol formation while still having to sufficient H₂ surplus to ensure high degree of hydrogenation of any oxygen and the sulfur impurities. Furthermore, with this embodiment the total gas flow is kept at a minimum, thus providing the smallest possible reactor and equipment size.

In another embodiment of the invention, hydrogen is added to the CO₂-rich gas feed in an amount corresponding to the feed composition to the downstream process for production of synthesis gas, methanol, synthetic fuels and other chemical products. As an example, for the production of methanol, the feed composition to the methanol process will be around 12% w/w H₂ and 88% w/w CO₂. This corresponds to a ratio of 3 moles H₂ per mole of CO₂. The advantage of this embodiment is that H₂ and CO₂ can be mixed and preferably compressed prior to the CO₂ cleaning. The CO₂ cleaning process can be located downstream the final compression step or between intermediate compression steps, whichever is best suited with regard to cost, water concentration, risk of carbonate formation on the guard material and risk of formation of undesired side products such as water and methanol. Another advantage of this embodiment is that any O₂ present in the H₂ rich feed will also become hydrogenated. H₂ from electrolysis of water can contain varying amounts of O₂, depending on the operation of the electrolyser.

The one or more sulfur-containing compounds adsorbed onto the guard material are typically selected from COS, SO₂ and H₂S, preferably SO₂. The guard material is suitably active in absorption of SO₂ and H₂S, and is preferably a Cu—Zn—Al guard material. In the presence of H₂, the guard material is capable of catalytically reducing the SO₂ in the CO₂ feed rich to H₂S, which is much more efficiently adsorbed on the guard than the SO₂. The guard is also capable of reacting oxygen content in the CO₂ feed stream with hydrogen to form water.

The process provides a cleaned CO₂-rich gas stream. This cleaned CO₂-rich stream typically comprises:
less than 500 ppb, preferably less than 100 ppb, preferably less than 50 ppb sulfur and more preferably less than 25 ppb sulfur,
less than 200 ppmV O₂, less than 100 ppmV O₂, less than 50 ppmV O₂ The guard material used in the process of the invention is suitably located within a reactor vessel, said reactor vessel being arranged to receive the CO₂-rich gas feed and the hydrogen-rich feed, optionally in admixture.

The guard material is preferably having a chemical composition of 25-60% w/w Cu, 15-70% w/w Zn, and optionally 2-10% w/w Al. It may comprise minor amounts of K and C as well. The elements will either be found in a reduced or oxidised state.

The CO₂ cleaning process is typically operated in the pressure range 1-100 bar, preferably 1-50 bar, depending on the pressure of the CO₂ feed stream and the pressure of the downstream conversion process.

To provide the best compromise between high catalytic/adsorption efficiency and low tendency for carbonate formation and evolution of undesired side reactions, such as water and methanol formation, the CO₂ cleaning process is typically operated in the 120-250° C. temperature range. A pressure in the interval 1-90 bar is also typical.

In one aspect, more than 95% of the one or more sulfur containing impurities are retained on the guard material or the total concentration of sulfur containing impurities in the cleaned CO₂-rich gas stream is <500 ppb, such as <100 ppb, such as <50 ppb.

As noted above, the cleaned CO₂-rich gas stream is sufficiently pure that catalyst poisoning of downstream processes is significantly reduced. The invention therefore provides a process for production of a syngas stream, said process comprising the process as described above, and further comprising:
providing at least a portion of said cleaned CO₂-rich gas stream from the process described herein;
providing a second hydrogen-rich feed, optionally obtained from the process of electrolysis of water in one or more electrolysis unit(s);
reacting said portion of the cleaned CO₂-rich gas feed with the second hydrogen-rich feed, to provide at least one syngas stream.

In this process, the step of reacting the portion of the cleaned CO₂-rich stream feed with the second hydrogen-rich feed, to provide at least one syngas stream may be carried out in the presence of a catalyst active in reverse water gas shift.

An integrated process can also take place, in which CO₂ cleaning, syngas production and subsequent downstream syntheses occur. Therefore, a process for production of a synthetic fuel stream is provided, said process comprising providing at least one syngas stream, as described herein, and further comprising the step of converting said at least one syngas stream to at least one synthetic fuel stream, preferably being a MeOH stream, a DME stream, or a synthetic fuel stream, preferably wherein said synthetic fuels are aviation fuel, gasoline or diesel fuels. In one aspect, the process of converting said at least one syngas stream to at least one synthetic fuel stream is a Fisher-Tropsch process, which provides a synthetic fuel stream. In another aspect, the process of converting said at least one syngas stream to at least one synthetis fuel stream is a TIGAS process, which provides a synthetic fuel stream.

### SPECIFIC EMBODIMENTS

FIG. 1 shows a simple layout of one embodiment of the process of the invention. A CO₂-rich gas feed 1 is mixed with a hydrogen-rich feed 2 and passed over a guard material 10 in reactor vessel 100. Sulfur-containing compounds are adsorbed on the guard material 10 and a cleaned CO₂-rich gas stream 50 is outputted.

FIG. 2 shows a layout for production of a syngas stream. The reactor vessel 100, CO₂-rich gas feed 1, hydrogen-rich feed 2 and cleaned CO₂-rich gas stream 50 are according to FIG. 1. Subsequently, a second hydrogen-rich feed 202 is reacted with the cleaned CO₂-rich stream feed 50, in a syngas section 300 to provide at least one syngas stream 301.

In FIG. 3 one embodiment for the layout of the CO₂ gas purification process is shown. The CO2 gas feed (1) comprising O₂ and one or more sulfur-impurities is mixed with an amount of a H2 rich gas (2). The mixed gas is sent to a compressor (5) in which the pressure is increased. The high-pressure feed gas (6) is then preheated in a heat exchanger (7) and the heated feed gas (9) is sent to the oxygen hydrogenation reactor (11) in which an oxygen hydrogenation catalyst (12) is installed and hydrogenates O₂ to H₂O. The substantially O₂ free CO₂ gas stream (17) is then cooled in heat exchanger (18) such that the feed gas (20) to the sulfur removal reactor (22) has the optimal temperature. In the reactor a guard material (10) is installed, removing sulfur impurities. The off-gas from the sulfur removal reactor (26) is substantially free of oxygen and sulfur impurities and can be further processed to synthesis gas and other products.

### Examples

Experiments have been carried out in a laboratory fixed bed reactor at isothermal condition to test the SO₂ removal efficiency of the guard material. The fixed bed reactor is placed in an electrically-heated oven and heated to the desired operating temperature.

Two internal thermocouples measure the inlet and exit temperatures in the catalytic bed. The oven is equipped with external thermocouples controlling the temperature zones in the oven. These zones are controlled by internal thermocouple readings to obtain isothermal reaction condition in the fixed bed.

The guard material is placed in the SilcoNert 2000™ coated stainless steel reactor on a grid and the reactor is aligned to be in the center of the electrical oven. Feed gases are mixed from gas cylinders using mass flow controllers controlling feed of the individual gases. These include nitrogen (N₂), hydrogen (H₂), carbon dioxide (CO₂), and 15 or 100 ppmV sulfur dioxide in methane (SO₂ in CH₄). Liquid water is supplied via a pump, passing through an evaporator and mixed with the feed gas upstream of the fixed bed reactor.

The guard material used is a coprecipitated Cu/ZnO/alumina-based guard material. In the individual test, where the guard material can be separated in several fractions (beds), the weight of the total guard material and the number of fractions/beds are given. Each fraction will typically be equally sized. The guard material has been crushed and sieved before loading to a particle fraction between 600 μm to 1000 μm from the original material size to achieve an optimal size in the laboratory reactor. Before measuring SO₂ removal from the CO₂ feed gas, the guard material was reduced in 2% H₂ in N₂ at 220° C. and 3 barg.

Table 1 lists the different tests carried out with SO₂ in the CO₂ feed gas and the exit analysis given are after 200 hours with continuous dosing of SO₂.

TABLE 1

| | Load | | | Inlet composition | | | | | | S-GC Exit |
|---|---|---|---|---|---|---|---|---|---|---|
| Test | Grams/# | T | P | H₂, | CO₂, | H₂O, | CH₄, | SO₂, ppm | Flow | SO₂ |
| # | of beds | ° C. | Barg | vol % | vol % | vol % | vol % | Vᵥ | NI/h | ppbVᵥ |
| 1a | 1.0/1 | 220 | 5 | 2 | 0 | 0 | 98^{N2} | 1.0 | 50 | <100 |
| 1b | | 220 | 5 | 70 | 24 | 0 | 7 | 1.0 | 51 | <100 |
| 1c | | 250 | 5 | 70 | 24 | 0 | 7 | 1.0 | 51 | <100 |
| 2 | 3.0/6 | 220 | 35 | 5 | 88 | 0 | 7 | 1.1 | 40 | <100 |
| 3 | 1.2/2 | 150 | 5 | 2.6 | 90 | 0 | 8 | 1.2 | 39 | <50 |
| 4 | 1.2/2 | 150 | 7 | 2.5 | 89 | 0 | 9 | 1.3 | 40 | <50 |
| 5a | 1.2/2 | 150 | 7 | 2.5 | 88 | 1 | 9 | 1.3 | 40 | 60 |
| 5b | | 180 | 7 | 2.5 | 88 | 1 | 9 | 1.3 | 40 | 2 (<50) |
| 6 | 4.3/6 | 180 | 7 | 2.5 | 88 | 1 | 9 | 1.3 | 40 | 6 (<50) |
| 7 | 5.4/7 | 180 | 7 | 2.5 | 88 | 1 | 9 | 1.3 | 40 | <50 |
| 8 | 5.4/7 | 200 | 7 | 2.5 | 88 | 1 | 9 | 1.3 | 40 | <50 |
| 9 | 5.4/7 | 220 | 7 | 2.5 | 88 | 1 | 9 | 8.8 | 40 | <dl |
| | | | | | | | | | | (60 h) |

The sulfur feed and exit gas concentration were measured on Agilent 7890A GC system equipped with an OI 5380 pulsed flame photometric detector (PFPD). Except experiments 1 and 2, where an Agilent 8355, S with a S Chemiluminescence Detector was used which had a higher detection limit of 100 ppbV. For the test #5b and 6, SO₂ exit analyses in Table 1 are estimated based on a sulfur balance as no SO₂ was measured below the detection limit of SO₂ at 50 ppbV. These results are shown in italic.

### Example (II)

The O₂ hydrogenation activity was investigated for Topsoe's O₂Xtract™ hydrogenation catalyst, comprising Pd and Pt as the active components. The hydrogenation activity was measured in a CO₂ feed gas comprising 2.5 vol % H₂, 2,000 ppm O₂ and either 0 or 10 ppm SO₂. The catalyst space velocity was 180,000 Nm³/h/m³ and the temperature was varied in the range 50-350° C. O₂ concentrations were measured at the inlet and outlet of the catalyst with a dedicated O₂ in CO₂ sensor and O₂ hydrogenation conversion was based on these concentrations. The conversions as a function of catalyst temperature are seen in FIG. 4. It is evident that the hydrogenation catalyst is very active in O₂ hydrogenation, but also that the catalyst activity is significantly hampered by the presence of SO₂. To be able to operate the O₂ hydrogenation catalyst without risking sulfur poisoning, the temperature should be higher than 200° C. and preferably closer to 250-350° C. or above.

### Example III

In a process layout as depicted in FIG. 3, the CO₂ feed gas is mixed with H₂ in amount corresponding to 3 mol H₂ per mol CO₂ after the CO₂ gas purification, making the mixed gas suitable for the production of methanol in a downstream synthesis plant.

The CO₂ feed gas contains 1 vol % O₂ and 5 ppm SO₂. The CO₂ feed gas is mixed with the entire H₂ feed and compressed to 90 barg and preheated to 185° C. in a dedicated heat exchanger, i.e. heat exchanger 7 in FIG. 3 is split up in a feed gas preheater with its own heat source, such as steam or electricity, and a feed/effluent heat exchanger, connecting the cold side of heat exchanger 7 with the hot end of heat exchanger 18.

The 185° C. feed gas is then preheated to 300° C. in the feed/effluent exchanger by heat exchange with the hot gas from the outlet of O₂ hydrogenation reactor 11. At this temperature, the O₂ hydrogenation catalyst is active and not poisoned by the SO₂ in the mixed gas. The O₂ hydrogenation reaction is highly exothermic and increase the temperature by 35° C. to 335° C., more than compensating for the temperature approach in the feed/effluent heat exchanger. To control the reactor inlet temperature, 15-20% of the hot gas from the O₂ hydrogenation reactor (17) bypasses the feed/effluent heat exchanger. The hot gas from the reactor is cooled to 195° C. in the feed/effluent heat exchanger and mixed with the bypassed hot gas to end up with a mixed temperature of 220° C. to the downstream guard material (10), well within the optimal temperature range for this process. The SO₂ become hydrogenated to H₂S and captured on the Cu and Zn sites of the guard material. The cleaned process gas can then be directed to the methanol synthesis plant at a temperature well suited for the methanol converter.

It is also an option to bypass a fraction of the cold gas to the feed/effluent heat exchanger instead of the hot gas bypass as described above.

Typically feed/effluent heat exchangers are designed with a minimum temperature approach of 10-20° C. to provide an economical and still efficient heat exchanger. In case the CO₂ feed contain 0.2 vol % O₂, the adiabatic temperature increase in the O₂ hydrogenation reactor in this example with be 7° C., which is in the lower than the normal design rules. The heat exchange surface can be increased to decrease the design temperature approach, or a small support heater can be installed to increase the temperature by the necessary 3-13° C. In principle an amount of O₂ could also be added to the CO₂ gas, providing more hydrogenation reaction and thus heat evolved but that may option be too expensive with regard to H₂ consumption, and the extra water formed will reduce the capacity of the guard material and conversion efficiency in the downstream methanol plant.

An alternative solution could also be to carry out the O₂ hydrogenation and sulfur removal before the addition of the total amount of hydrogen, i.e. with 3 vol % H₂ which is still sufficient for the O₂ and sulfur hydrogenation. Due to the lower gas volume, the adiabatic temperature increase is now 21° C. and a feed/effluent heat exchanger will work efficiently without modifications.

For high O₂ concentrations in the CO₂-rich and H₂-rich feed streams, the formed water vapor may beneficially be removed at a position upstream the guard material and synthesis plant. Water removal can be achieved by cooling the gas mixture to a temperature below the water dew point to condense and withdraw a fraction of the water as liquid.

The present invention has been described with reference to a number of aspects and figures. However, the skilled person is able to select and combine various aspects within the scope of the invention, which is defined by the appended claims. All documents referenced herein are incorporated by reference.

1. A process for cleaning a CO₂-rich gas feed, said CO₂-rich gas feed comprising at least 80 wt % CO₂ and one or more sulfur-containing impurities; wherein said process comprises the step of:
passing the CO₂-rich gas feed together with a hydrogen-rich feed over a guard material, and adsorbing one or more sulfur-containing compounds on said guard material, to provide a cleaned CO₂-rich gas stream.

2. The process according to claim 1, wherein the CO₂-rich gas feed comprises at least 90 wt % CO₂.

3. The process according to claim 1, wherein the one or more sulfur-containing impurities within said CO₂-rich gas feed are selected from organosulfur compounds.

4. The process according to claim 1, wherein the guard material is active in reduction of SO₂ to H₂S and adsorption of H₂S.

5. The process according to claim 1, wherein the guard material is located within a reactor vessel, said reactor vessel being arranged to receive said CO₂-rich gas feed and said hydrogen-rich feed, optionally in admixture.

6. The process according to claim 1, wherein the sulfur containing impurity is SO₂ and the concentration of SO₂ in the CO₂-rich gas feed is 0.1-50 ppm SO₂.

7. The process according to claim 1, wherein the CO₂-rich gas feed, and/or hydrogen-rich feed, additionally comprise(s) oxygen, and wherein the process comprises the additional step of:
passing the CO₂-rich gas feed together with said hydrogen-rich feed over a catalyst active in hydrogenation of oxygen and reducing the oxygen in the CO₂/H₂ gas mixture, to provide a first oxygen depleted CO₂-rich gas stream,
prior to the step of passing the first oxygen depleted CO₂-rich gas feed over the guard material for absorbing one or more sulfur-containing impurities, to provide a cleaned CO₂ rich gas stream.

8. The process according to claim 1, wherein the total content of O₂ in the CO₂-rich gas feed is 50-10,000 ppm O₂.

9. The process according to claim 1, wherein more than 95% of the O₂ is converted on the catalyst active in hydrogenation of oxygen or the total concentration of O₂ in the cleaned CO₂-rich gas stream is <200 ppm.

10. The process according to claim 1, wherein the step of passing the CO₂-rich gas feed and hydrogen-rich feed over a catalyst active in hydrogenation, takes place at a temperature in the interval 200-400° C. and a pressure in the interval 1-90 bar.

11. The process according to claim 1, wherein the total content of H₂ in the combined feed of the CO₂-rich gas feed and the hydrogen-rich feed, after mixing of said feeds and passing the mixture over the optional O₂ hydrogenation catalyst and guard material, is 0.2-10 vol % H₂.

12. The process according to claim 1, wherein the total content of H₂ in the combined feed of the CO₂ rich gas feed and the hydrogen rich feed, after mixing of said feeds, corresponds to a ratio of 2-5 moles H₂ per mole CO₂.

13. The process according to claim 1, wherein the total content of H₂O in the combined feed of the CO₂-rich gas feed and the hydrogen-rich feed, after mixing of said feeds, is no more than 10 vol %.

14. The process according to claim 1, wherein the step of passing the CO₂-rich gas feed and hydrogen-rich feed over a guard material, takes place at a temperature in the interval 120-250° C. and a pressure in the interval 1-90 bar.

15. The process according to claim 1, wherein more than 95% of the one or more sulfur containing impurities are retained on the guard material or the total concentration of sulfur containing impurities in the cleaned CO₂-rich gas stream is <500 ppb.

16. The process according to claim 1, wherein the CO₂ feed is derived from a renewable source.

17. A process for production of a syngas stream, said process comprising the process according to claim 1, and further comprising:
providing at least a portion of said cleaned CO₂-rich gas stream;
optionally, providing a second hydrogen-rich feed, optionally obtained from the process of electrolysis of water in one or more electrolysis unit(s);
reacting said portion of the cleaned CO₂-rich stream feed with the second hydrogen-rich feed, to provide at least one syngas stream.

18. The process according to claim 17, wherein the step of reacting said portion of the cleaned CO₂-rich stream feed with the second hydrogen-rich feed, to provide at least one syngas stream is carried out in the presence of a catalyst active in reverse water gas shift.

19. A process for production of a synthetic fuel stream, said process comprising the process according to claim 17, and further comprising the step of converting said at least one syngas stream to at least one synthetic fuel stream, a synthetic fuel stream, or a TIGAS stream.
